(19) United States
(12) Patent Application Publication
(10) Pub. No.: US 2011/0274384 A1
(43) Pub. Date: Nov. 10, 2011

(54) AXIAL THRUST BEARING SYSTEM

(76) Inventors: Bruno Montboeurf, Cerelles (FR); Richard Corbett, Fondettes (FR); Christophe Houdayer, Semblancay (FR); Samuel Viault, Rocher (FR); Jérôme Dubus, La Riche (FR)

(21) Appl. No.: 13/145,183

(22) PCT Filed: Feb. 3, 2010
(86) PCT No.: PCT/EP10/51273

§ 371 Date: Jul. 19, 2011

(30) Foreign Application Priority Data
Feb. 5, 2009 (FR) 0950730

(51) Int. Cl. F16C 33/76; F16C 19/10

(52) U.S. Cl. 384/607

(57) ABSTRACT

An axial thrust bearing system comprises a rolling bearing (6) which comprises an upper race (7) secured to an upper cover (4), a lower race (8) secured to a bearing seat (5), rolling elements (9) between the two races, and a cage (10) for retaining these rolling elements. At least one of the races consists of a part separate from the upper cover or from the bearing seat. The cage comprises a framework portion(15) keeping the rolling elements (9) on a rolling circumference, a first lip (16a, 16d) and a second lip (16b, 16c) each extending radially from a periphery of the framework respectively towards the outside and towards the inside of the rolling circumference (17). The first and the second lips (16a-16b, or 16d-16c) are both in sealed contact, on either side of the separate part, with a substantially radial surface portion of the upper cover (4a) or of the bearing seat (5a).

The present invention relates to the field of axial thrust bearings, particularly designed for suspension devices, used in particular on motor vehicles in wheel suspension arms, or the field of clutch thrust bearings of motor vehicles.

Conventionally, an axial thrust bearing comprises an upper race and a lower race between which rolling elements retained by a cage are placed.

Conventionally, a suspension bump stop comprises an axial thrust bearing placed between lower and upper covers, forming housings for the lower and upper races of the axial thrust bearing respectively. The suspension bump stop is placed in the upper portion of the suspension arm between a suspension spring and an upper element secured to the body of the vehicle. The suspension spring is placed around a shock-absorber piston rod the end of which may be secured to the body of the vehicle. The spring presses axially, directly or indirectly, on the lower cover supporting the axial thrust bearing. In the rest of the text, the axial thrust bearing will sometimes be referred to by the simplified term of “rolling bearing”.

The suspension bump stop therefore makes it possible to transmit axial forces between the suspension spring and the body of the vehicle while allowing a relative angular movement between the lower cover that can rotate and the upper cover. This relative angular movement can be the result of a turning of the steering wheels and/or of the compression of the suspension spring.

A clutch thrust bearing is used to apply an axial force to the fingers of a clutch diaphragm, which fingers are in frictional contact with one of the races of the thrust bearing or a cover secured to this race. This first race is rotated by the friction of the fingers. A clutch fork applies the axial clutch-release force to the thrust bearing. This fork is articulated, directly or indirectly, about a diameter of the other race of the thrust bearing, preventing this other race from rotating relative to the axis of the thrust bearing.

The inside of the rolling bearing, that is to say the space between the two races, contains a lubricant. For the correct operation of the rolling bearing, the lubricant needs to be kept inside the rolling bearing and at the same time solid or liquid pollutants must be prevented from entering the rolling bearing. Accordingly, seals may be placed at the junction between the two races. These seals may be attached either to one of the races or to the cage for retaining the rolling elements. In the latter case, an economy is made on compactness and on sometimes costly slide systems when guiding grooves have to be machined in one or other of the races. Moreover, the angular speed of the cage relative to the fixed race is approximately half the angular speed of the rotating race of the rolling bearing. The speed of wear of a seal secured to the cage and rubbing on one or other race is less than that of a seal fixed to one of the races and rubbing on the other race.

Japanese Patent Application JP 2006 322556 describes such a rolling bearing in the form of an axial thrust bearing with a metal cage to which are assembled radial double lips comprising two superposed half-lips the axial section of which is a “V” the apex of which is attached to the cage. The end of each half-lip comes into frictional circumferential contact with an edge of one of the races, the pressure between the half-lip and the race being substantially radial.

This solution is awkward to apply, because, during a radial misalignment of the lower cover relative to the upper cover due, for example, to manufacturing tolerances, a frictional torque of the rolling bearing is obtained that differs from that planned in the unassembled state of the rolling bearing. This unnecessary, non-uniform friction on the circumference of the rolling bearing may cause generation of undesired noise and premature wear of the friction lips. Moreover, the considerable circumferential stresses between the lips and the metal cage may separate the lips from the cage.

French Patent Application FR 2 779 096 describes a suspension bump stop furnished with a cage made of synthetic material, which is extended on one side or on two sides by one or more sealing lips rubbing on the lower race, on the upper race, or on the upper cover. The sealing contacts of the lips are made at least partly with warped surfaces, that is to say at the fillets of a change of section of the contacted part. This solution is also not fully satisfactory, because in the event of radial movement of the upper portion of the bearing relative to the lower portion of the rolling bearing, the sealing lip, relatively rigid because it is made of the same material as the central portion of the retention cage, no longer provides the desired seal on one side of the rolling bearing, and, on the other side of the rolling bearing, sustains friction forces that are substantially greater than intended. These non-symmetrical frictions will cause radial vibrations of the rolling bearing.

The object of the invention is to propose a suspension bump stop for which the friction torque of the lips is substantially the same irrespective of the relative radial positioning of the lower and upper covers, at an attractive manufacturing price, and with optimal sealing performance.

The object of the invention is an axial thrust bearing system, comprising a bearing seat, an upper cover placed facing the bearing seat, and a rolling bearing interposed between the upper cover and the bearing seat. The rolling bearing comprises an upper race secured to the upper cover, a lower race secured to the bearing seat, rolling elements between the two races, pressing axially on each of the races and travelling on the latter, and a cage for retaining these rolling elements. The cage comprises a framework portion keeping the rolling elements on a rolling circumference and at least one circumferential sealing lip extending from the framework to the inside or to the outside of the rolling circumference and made of a more flexible material than the material of the framework. Each of said lips is in sealed contact with a substantially radial surface portion. Preferably, each of the lips is in sealed contact with an exactly radial surface portion.

Advantageously, the lips have a geometry of revolution about the axis of the rolling bearing.

Advantageously, at least one of the lips is a double lip in sealed contact with two surfaces axially facing one another.

In particular, one of the lips of the cage may be a double lip with a Y-shaped axial section, the two arms of the “Y” being in sealed contact with two radial surfaces axially facing one another.

In a preferred embodiment, the cage comprises at least one lip extending from the framework to the inside of the rolling circumference, and at least one lip extending from the framework to the outside of the rolling circumference.

Advantageously, the cage comprises a first double lip in sealed contact with two first surfaces axially facing one another, and comprises a second double lip in sealed contact with two second surfaces axially facing one another. According to a variant embodiment, at least one of the first surfaces and one of the second surfaces are in one and the same plane. In particular, the first and second surfaces may both be in two parallel planes, which makes it possible to have directions of sealed contact forces that are symmetrical relative to a mid-plane, so forces will balance one another out easily. According to another variant embodiment, the four surfaces are in radial planes of different axial positions. This configuration may make it possible for example to optimize the axial space requirement of the rolling bearing.

Advantageously, the framework comprises insert elements separating the rolling elements and two groups of lateral elements connecting the inserts, defining housings for the rolling elements, in which housings the rolling elements are kept on the rolling circumference. The cage may comprise, in this configuration, at least one lip coupled, by a continuous coupling layer, to one of the groups of lateral elements. The lip may be divided in two, in the sense that the coupling layer can divide into two lips separated by an axial distance which increases when one moves radially away from the rolling circumference along the lips. Certain, or all, of the insert elements may consist of a solid volume, with an axial dimension greater than the axial dimension of the lateral elements. The axial dimension of an insert element may also be greater than the thickness of the insert, that is to say greater than the shortest distance separating two rolling elements. The lateral elements may delimit a portion of the contour of axial apertures arranged in the framework, these apertures being separated, by the lateral elements, from the housings of the rolling elements.

Preferably, at least one lip is in sealed contact with the upper race or the upper cover, and at least one lip is in sealed contact with the lower race or the bearing seat, the normals of the surfaces of contact of the lips with the races, the cover or the seat all forming angles of less than 30° relative to the axis of the rolling bearing.

According to a preferred embodiment, the cage comprises at least one lip extending towards the inside of the rolling circumference, said lip being in sealed contact with the upper cover, and comprises at least one other lip extending towards the outside of the rolling circumference, said other lip being in sealed contact with the upper cover. In this configuration, the upper race is isolated from the environment external to the rolling bearing, which makes it possible to economize on costly protective surface treatments of this race, for example against rust.

According to another preferred embodiment which may be combined with the preceding embodiment, the cage comprises at least one lip extending towards the inside of the rolling circumference, said lip being in sealed contact with the bearing seat, and comprises at least one other lip extending towards the outside of the rolling circumference, said other lip being in sealed contact with the bearing seat. In this configuration, the lower race is isolated from the environment external to the rolling bearing, which makes it possible to economize on costly protective surface treatments of this race.

According to another advantageous variant embodiment, all the lips are in sealed contact with the upper race, or with the lower race. Because of the good surface hardness and slight roughness of the races, the wear of the lip seals is then less than if there is friction of the elastomer lips on a surface made of plastic, such as the plastics often forming the upper cover or the bearing seat. Advantageously, the surfaces of the races, of the bearing seat or of the cover in contact with the lips are in symmetry of revolution about the axis of the bearing.

Advantageously, the lower portion of the upper cover comprises a circumferential channel capable of covering the upper circumference of the bearing seat, while encompassing the upper race of the rolling bearing and at least a portion of the lower race of the rolling bearing, at least one lip being in frictional contact with a radial surface portion of the channel, inside the channel.

In one particularly advantageous embodiment, the framework of the cage has concave surface portions, and the material of the circumferential lip or lips at least partly fills the concavities defined by these concave surfaces.

In a preferred variant of the preceding embodiment, the cage is traversed axially by orifices placed on a circumference internal and/or external to the rolling circumference, said orifices being at least partly filled by the material of the circumferential lip or lips. These orifices may consist of axial apertures delimited, in part, by the lateral elements of the cage.

In this manner, the mechanical coupling of the lips to the framework is enhanced with respect to axial pulling forces as well as with respect to tangential pulling forces.

In a preferred embodiment, the cage is made by moulding of the circumferential lip or lips over the framework.

Advantageously, the material of the lip or lips is a thermo-plastic elastomer the melting temperature of which is lower than the melting temperature of the material of the framework.

The framework may be made from a polyamide, polybutylene terephthalate or polypropylene matrix, which may or may not be filled, and the circumferential lip or lips may be made from thermoplastic polyurethane.

In a variant embodiment, the framework may be metallic, and the circumferential lip or lips may be made of thermoplastic elastomer or of interlaceable elastomer overmoulded onto the framework.

According to another aspect, the subject of the invention is a motor vehicle suspension bump stop, that is to say an axial thrust bearing system as described above, in which the upper cover is secured to the chassis of the vehicle, and the bearing seat rests directly or indirectly on a spring of the vehicle suspension.

The present invention will be better understood on reading the detailed description of embodiments taken as examples that are in no way limiting and are illustrated by the appended drawings in which:

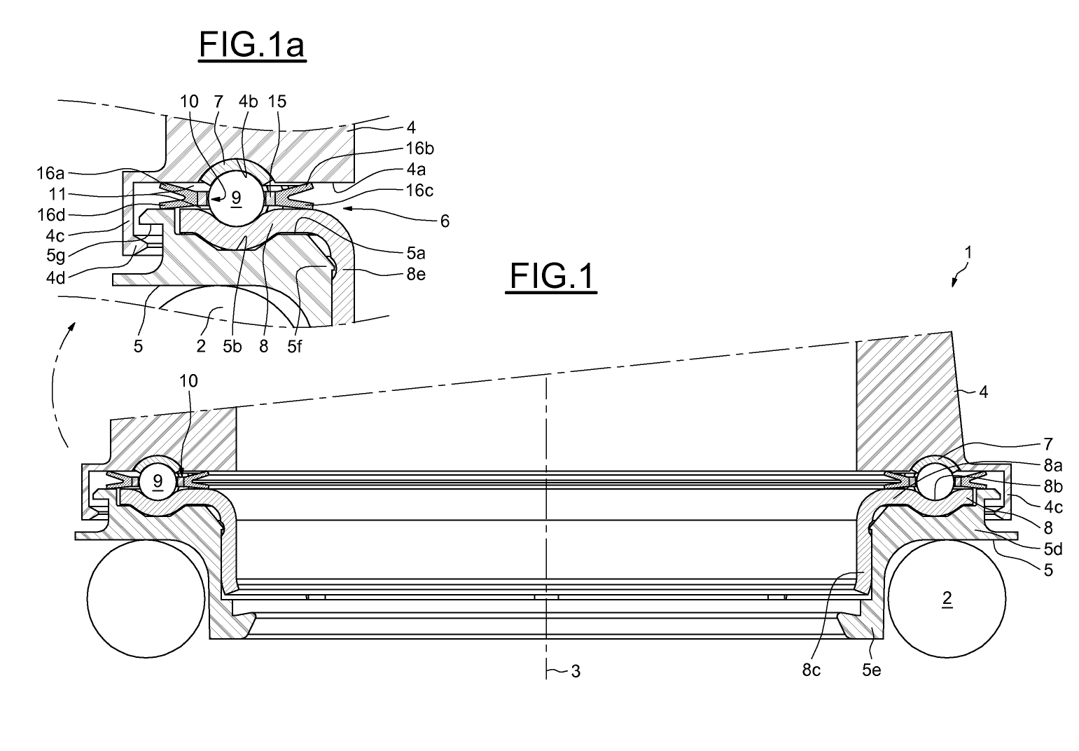

FIG. 1 is a view in axial section of a suspension bump stop device according to a first embodiment of the invention,

FIG. 1a is a detail of a portion situated to the left of FIG. 1,

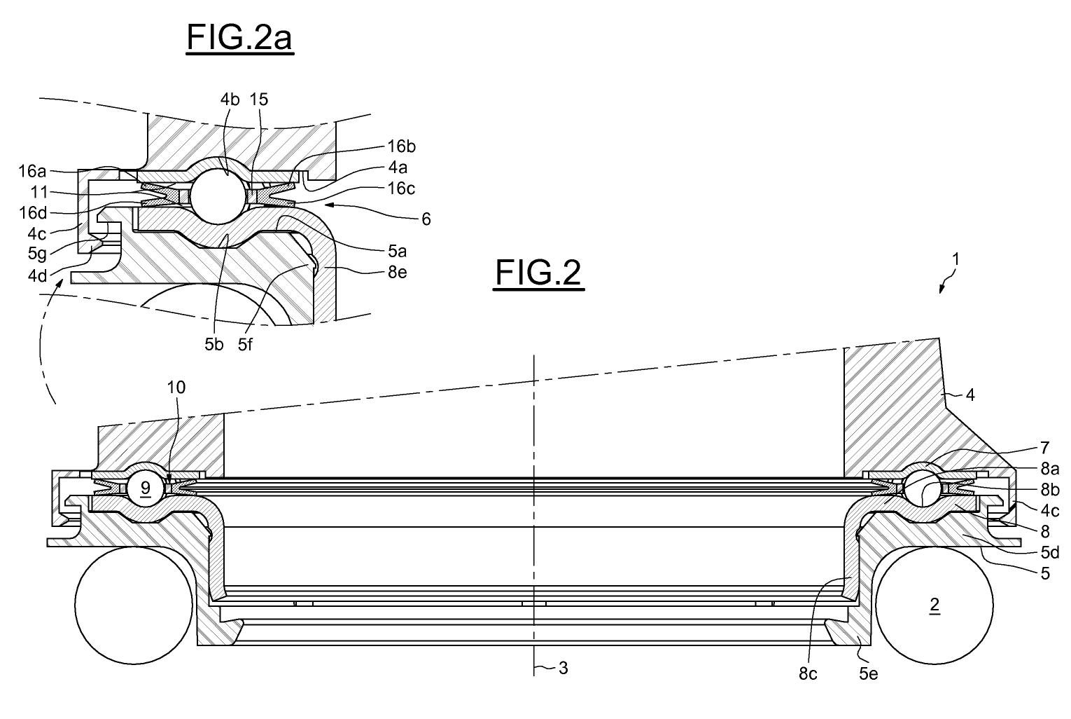

FIG. 2 is a view in axial section of a suspension bump stop device according to a second embodiment of the invention,

FIG. 2a is a detail of a portion situated to the left of FIG. 2,

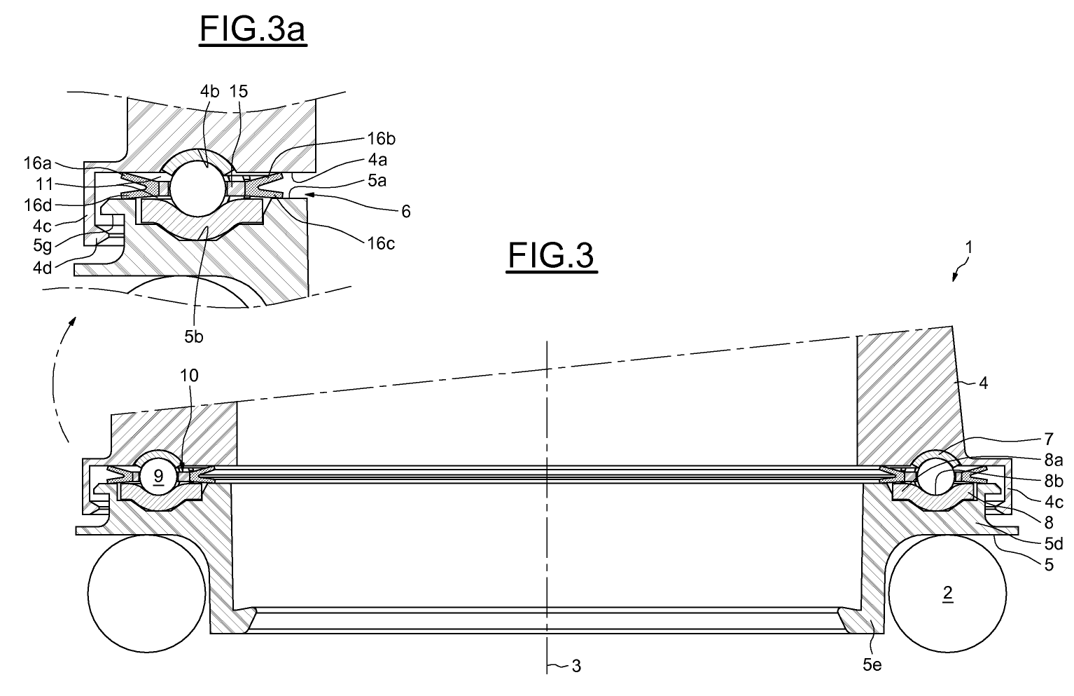

FIG. 3 is a view in axial section of a suspension bump stop device according to a third embodiment of the invention,

FIG. 3a is a detail of a portion situated to the left of FIG. 3,

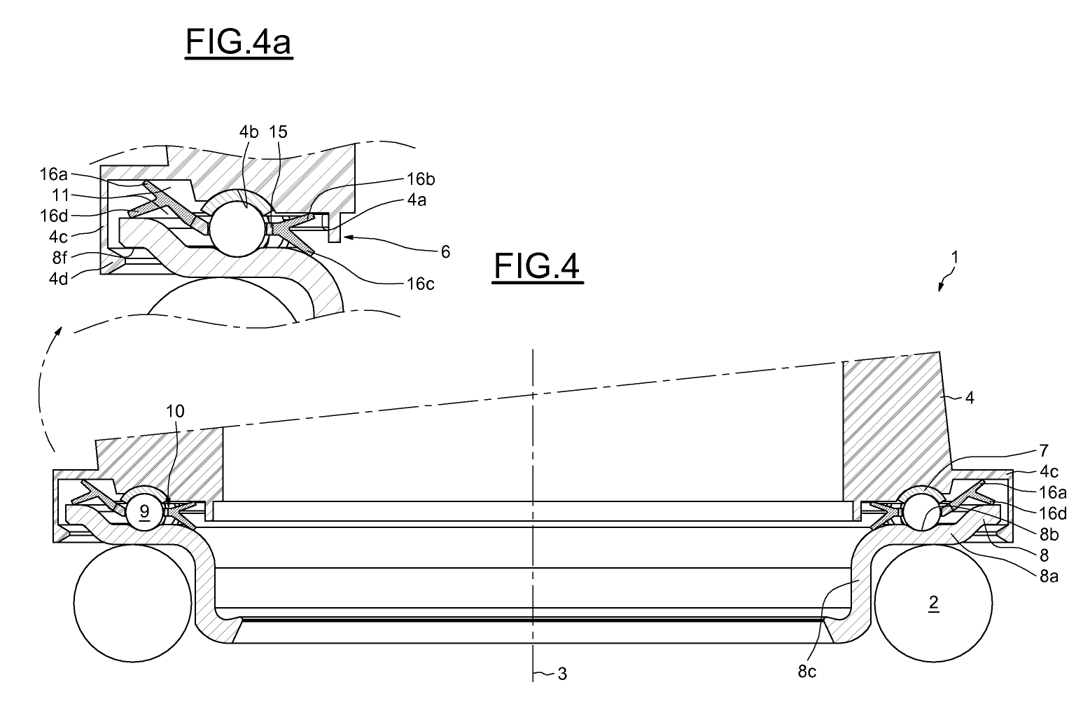

FIG. 4 is a view in axial section of a suspension bump stop device according to a fourth embodiment of the invention,

FIG. 4a is a detail of a portion situated to the left of FIG. 4,

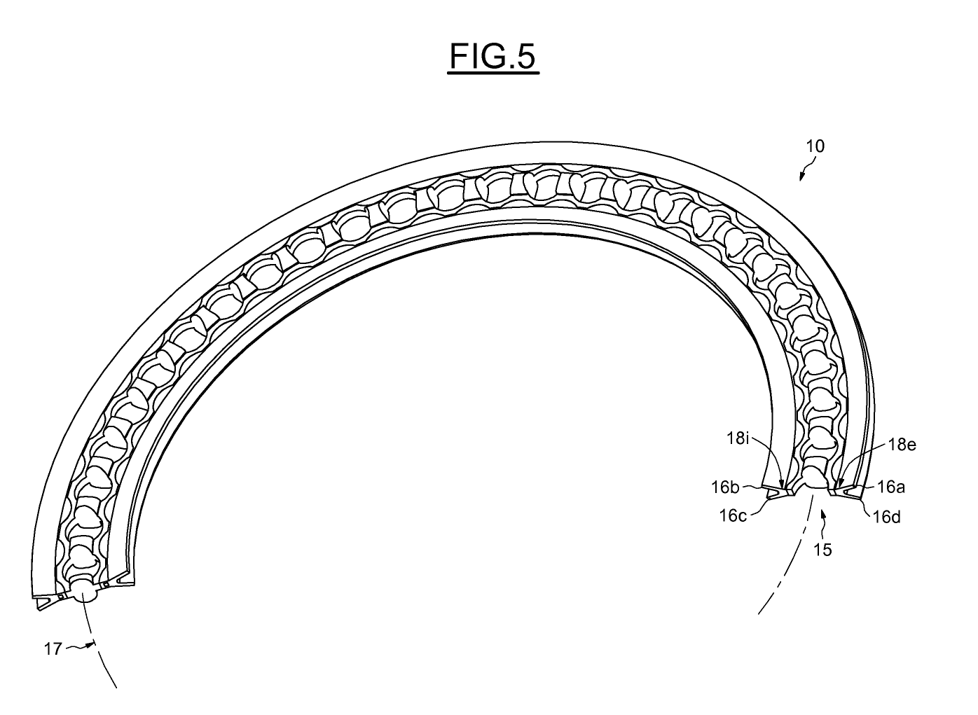

FIG. 5 is a view in perspective of a rolling bearing cage of a rolling bearing device according to the invention,

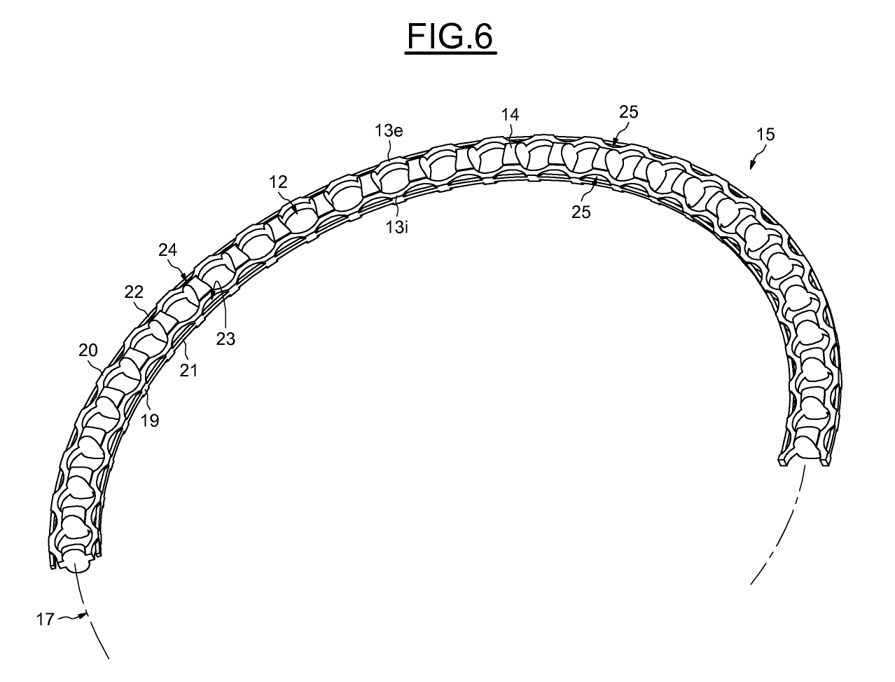

FIG. 6 is a view in perspective of a framework of a rolling bearing cage according to the invention,

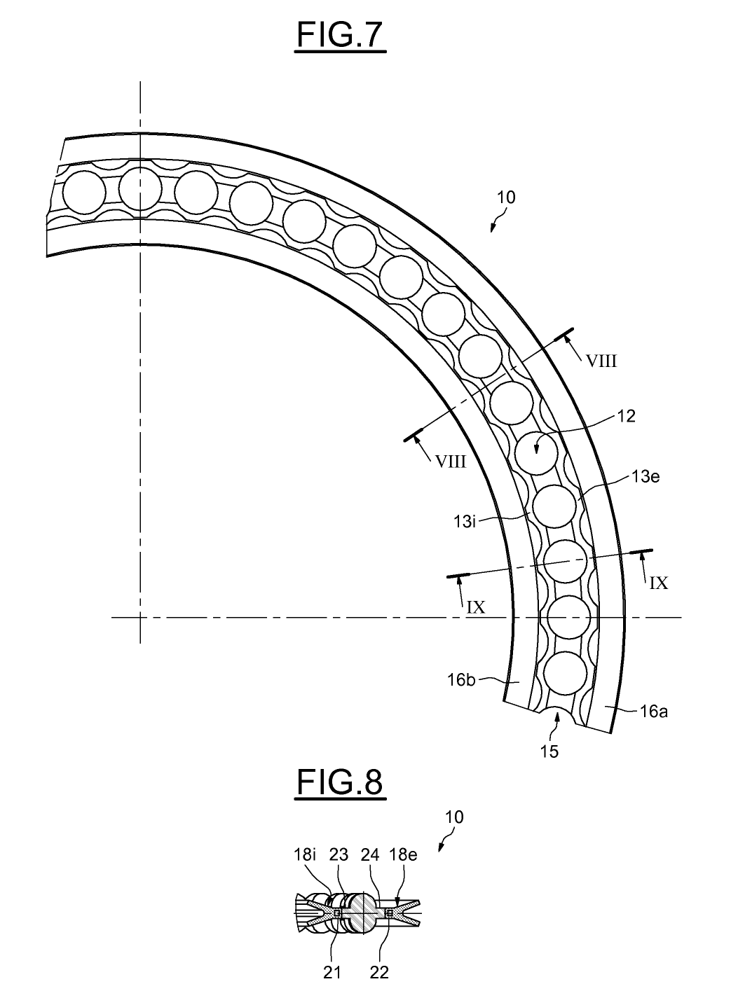

FIG. 7 is a top view of a rolling bearing cage of a rolling bearing device according to the invention,

FIG. 8 is a view in section VIII-VIII of the cage represented in FIG. 7,

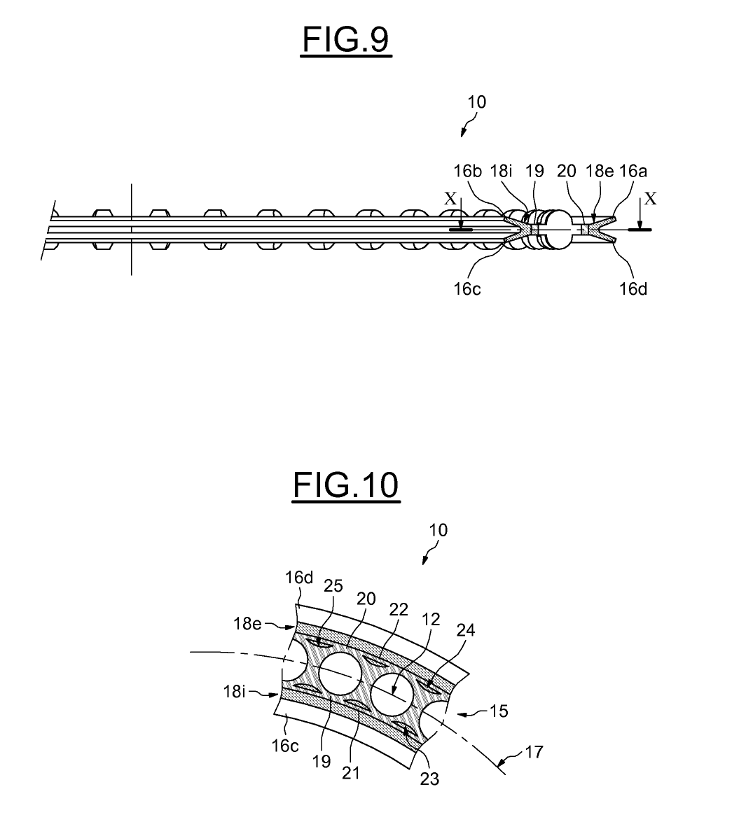

FIG. 9 is a view in section IX-IX of the cage represented in FIG. 7,

FIG. 10 is a view in section X-X of the cage represented in

FIG. 9.

The reference numbers mentioned in the rest of the description with reference to FIGS. 1, 2, 3, 4 partly appear in their respective detail views 1a, 2a, 3a, 4a instead of FIGS. 1, 2, 3, 4 themselves. FIGS. 1 to 4 show four different embodiments of the invention.

As shown in FIG. 1, a suspension bump stop device, designated by general reference number 1, is designed to be mounted between an upper bearing seat (not shown) capable of resting directly or indirectly in an element of a chassis of the motor vehicle, and a coil spring 2. The suspension bump stop 1 is placed around a shock-absorber rod (not shown) extending along a substantially vertical axis 3, the spring 2 being mounted around said rod.

The suspension bump stop 1 mainly comprises an upper supporting cover 4, a bearing seat 5, and a rolling bearing 6 placed axially between the upper cover and the bearing seat. The rolling bearing 6 comprises an upper race 7 made of pressed metal sheet, a lower race 8 also made of pressed metal sheet, and a row of rolling elements made in this instance in the form of balls 9. The upper race 7 is in contact with a lower surface 4a of the upper cover 4, and the lower race 8 is in contact with an upper surface 5a of the bearing seat 5.

The lower race 8 is dish-shaped, with a radial portion 8a comprising a groove 8b serving as a raceway for the balls 9, said radial portion pressing against the upper face 5a of the bearing seat, and an axial portion 8c in the shape of a cylindrical skirt being inserted inside an axial skirt 5e of the bearing seat 5. The axial portion 8c comprises, on the face of its outer radius, a circumferential groove 8e which interacts with a circumferential protuberance 5f of the bearing seat 5, situated on the inner face of the axial skirt 5e of the seat. The dish-race 8 is therefore held axially relative to the bearing seat 5.

The rolling bearing 6 comprises a cage 10 capable of keeping the centres of the balls 9 evenly spaced along a rolling circumference, which represents the trajectory of the balls. The cage 10 comprises a rigid framework 15 which surrounds each of the balls 9 in order to keep it on the rolling circumference, and circumferential lips 16b, 16c, 16d, 16a made of a more flexible material than that of the framework. Each of the lips is in sealed contact, via an annular surface, with a radial surface portion, that is to say a surface portion the normal of which is parallel to the axis of the rolling bearing. The lips 16a and 16b, radially on either side of the framework, are in sealed contact with the lower face 4a of the upper cover. The lip 16d, radially on the outside relative to the framework, is in sealed contact with the upper face 5a of the bearing seat. The lip 16c, radially on the inside relative to the framework, is in sealed contact with the lower race 8 of the rolling bearing. The lips may be deformed by compression in the zone of contact. The sealing effect is then provided by an annular friction surface, more precisely a flat-ring-shaped surface the normal of which is parallel to the axis of the rolling bearing.

The upper cover 4 may consist in a monobloc part made of plastic, for example of polyamide PA 66 which may or may not be reinforced with glass fibres or other mineral fillers. The upper cover has the general shape of a truncated cone pierced with a bore with the same axis as the cone. In the lower face 4a of the upper cover, a circular groove 4b is formed making it possible to centre the upper race 7 of the rolling bearing.

The bearing seat 5 is a part of revolution comprising a radial skirt 5d supporting the upper bearing surface 5a of the rolling bearing. The radial skirt 5d has an external diameter greater than the diameter of the spring 2, the median diameter being that of the coil defined by the centre of the wire of the spring. The radial skirt 5d may therefore come to bear on the upper portion of the spring 2. The bearing seat 5 also comprises an axial skirt 5e the external diameter of which is slightly smaller than the internal diameter of the winding of the spring 2, so as to be able to be inserted inside the winding.

In the upper face 5a of the bearing seat, a circular groove 5d is formed making it possible to centre the lower race 8 of the rolling bearing. The bearing seat 5 may be made of synthetic plastic, for example of the same material as the upper cover 4, or of a different material.

The lower portion of the upper cover 4 comprises a circumferential channel 4c covering the upper circumference of the bearing seat 5, while encompassing the upper race 7 of the rolling bearing, and an upper portion of the lower race 8 of the rolling bearing. The circumferential channel 4c comprises a radial return 4d capable of snap-fitting under a shoulder 5g of the bearing seat 5. The circumferential lips 16a, 16b, 16c, 16d of the cage, the upper race 7, the lower face 4a of the upper cover, the lower race 8 and the upper face 5a of the bearing seat define a sealed space 11 containing the balls 9 and a lubricant (not shown). The sealed space 11, sealed by annular zones of contact of the lips with the lower race, the upper cover or the bearing seat, prevents leaks of lubricant to the outside of the rolling bearing, and the entry of pollutants (water, particles that may or may not be abrasive, other pollutants capable of diluting the lubricant, etc.). This sealed space, as illustrated in FIG. 1, protects the upper race 7 from external aggressive elements, making it possible to carry out, as required, protective surface treatments on only the lower dish-race 8.

FIG. 5 shows a rolling bearing cage 10 of a rolling bearing device according to the invention. The rolling bearing cage comprises a pierced central framework 15 placed generally on a rolling circumference 17. In the plane of the rolling circumference 17, the two lips 16b, 16c are attached to the framework 15 by a layer forming a coupling circumference 18i and situated towards the inside of the rolling circumference 17, and the two lips 16a, 16d are attached to the armature 15 by a layer forming a coupling circumference 18e and situated towards the outside of the rolling circumference. The lips 16b and 16c separate from one another and separate from the plane of the rolling circumference as one moves axially along the lip away from the rolling circumference. The assembly consisting of the two lips 16b, 16c and the coupling layer 18i forms a divided lip, the axial section of which is V-shaped, the coupling layer 18i forming the apex of the “V”. The lips 16a and 16d separate from one another and separate from the plane of the circumference of the rolling bearing as they move axially away from the rolling circumference. The assembly consisting of the two lips 16a, 16d and the coupling layer 18e forms a divided lip, the axial section of which is V-shaped, the coupling layer 18e forming the apex of the “V”.

FIG. 6 shows the central framework 15 of the cage 10 of FIG. 5. This contains elements common to FIG. 5, the same elements then being designated by the same reference numbers. The framework 15 defines a circular string of housings 12 of generally spherical shape and designed each to contain a ball 9. Each housing 12 is delimited by two inserts 14 extending radially between an inner cradle 13i and an outer cradle 13e. In the plane of the rolling circumference 17, the place where two cradles 13i or two cradles 13e join forms a concave zone 25. In the places where the housings 12 generally have a maximum diameter, the cradles 13i (respectively 13e) form protuberances 19 (respectively 20) relative to the concave zones 25. Each pair of two adjacent protuberances 19 (respectively 20) is connected by an overmoulding bar 21 (respectively 22). Each overmoulding bar 21 (respectively 22) and the concave zone 25 facing it defines a coupling aperture 23 (respectively 24).

FIGS. 7, 8, 9 and 10 are a top view and sectional views of the cage of FIG. 5. It contains elements common to FIGS. 5 and 6, the same elements then being designated by the same reference numbers. Note in FIGS. 8 and 10 that the material of the lips in their circumferential coupling region 18i (respectively 18e) fills the coupling apertures 23 (respectively 24) while encompassing the overmoulding bars 21 (respectively 22).

The framework 15 of the cage 10, which must be sufficiently rigid to keep the balls equidistant along their raceway and in order to prevent the cage from bending in the plane of the balls, may advantageously be made by moulding rigid plastic materials such as polyamide, particularly polyamide 66, polypropylene, particularly the polypropylenes with enhanced injection fluidity, for example with an MFI (Melt Flow Index) greater than 30 g/10 min (measurement according to the standard ASTM DI238), or polybutylene terephthalate, these polymer matrices being filled or not with mineral reinforcements, fibres, particles or nano-fillers. The Young's moduli at ambient temperature and in the dry state of such materials are typically in ranges from 2 GPa to 30 GPa. The sealing lips 16a, 16b, 16c, 16d may advantageously be overmoulded by injection onto the cage of a thermoplastic elastomer such as TPU or thermoplastic polyurethane. Typically, the deformability of these materials may be ascertained by a stress at 100% of static deformation which is at ambient temperature less than 10 MPa. The user will then have the benefit of choosing a grade of TPU or of other plastic elastomer of which the recommended injection temperature is below the melt temperature of the material used to manufacture the framework.

FIG. 2 depicts an embodiment similar to that of FIG. 1. It contains elements common to FIG. 1, the same elements therefore bearing the same reference numbers. Unlike FIG. 1, the upper race 7 of the rolling bearing is wider in the radial direction than the totality of the cage, so that the lips 16a and 16b, radially on either side of the framework, are in sealed contact with the upper race 7 of the rolling bearing. The outer bearing surface of the lower race 8 is also wider, so that the lips 16c and 16d, radially on either side of the framework, are both in sealed contact with the upper race 8 of the rolling bearing. The lips 16a, 16b, 16c, 16d of the cage, the upper race 7, and the lower race 8 define a sealed space 11. In this embodiment, the friction of the lips occurs only on the races 7 and 8 of the rolling bearing, that is to say on a steel surface, whereas for other embodiments, particularly that of FIG. 1, at least one of the lips rubs on a plastic surface of the upper cover or of the bearing seat. This embodiment is in this sense particularly advantageous because it reduces the wear by friction of the elastomer lips.

FIG. 3 describes an embodiment similar to that of FIG. 1. It contains elements common to FIG. 1, the same elements therefore bearing the same reference numbers. Unlike FIG. 1, the lower race 8 is shown as a flat ring the whole lower surface of which is pressing against the upper face 5a of the bearing seat 5, the ring being curved by a circumferential groove 8b at its median radius, in order to form a raceway for the balls 9. The lower portion of the upper cover 4 comprises a circumferential channel 4c covering the upper circumference of the bearing seat 5, while encompassing in the volume contained beneath the upper cover the totality of the two rolling bearing races 7 and 8. Each of the lips (16a, 16b, 16c, 16d) is in sealed contact, via an annular surface, with a radial surface portion. The lips 16a and 16b, radially on either side of the framework, are in sealed contact with the lower face 4a of the upper cover. The lips 16c and 16d, radially on either side of the framework, are in sealed contact with the upper face 5a of the bearing seat. In this embodiment, the bearing surfaces of the lips are all strictly radial, so that, in the event of radial movement of the cage, the annular contact zone moves slightly without changing surface or orientation, and the forces between the lips and their opposing surfaces are virtually unmodified. As for the exemplary embodiment of FIG. 1, the lips 16a, 16b, 16c, 16d of the cage, the upper race 7, the lower face 4a of the upper cover, the upper face 5a of the bearing seat, and the lower race 8 define a sealed space 11. However, in the present embodiment, as illustrated in FIG. 3, the sealed space entirely contains the upper race 7 and the lower race 8. By virtue of this configuration, the races 7 and 8 are protected from chemical attacks (corrosion) and mechanical attacks (abrasion) from the environment external to the rolling bearing. The lubricant present in the space 11 makes it possible to provide them with sufficient protection in the absence of particular surface treatments. This configuration is therefore particularly advantageous from the economical point of view, because it makes it possible to avoid carrying out costly surface treatments on the races.

FIG. 4 presents a fourth embodiment of the invention. FIG. 4 contains the same main elements as FIGS. 1 to 3, the same elements therefore bearing the same reference numbers. As in FIGS. 1 and 2, the lower race 8 is dish-shaped, but the external diameter of the axial portion 8c of the race is this time complementary to the internal diameter of the spring 2, the lower race 8 also performing the function of bearing seat. Because of this, the lower portion 4a of the upper cover 4 comprises a circumferential channel 4c covering the upper circumference of this lower race 8, while encompassing the upper rolling bearing race 7 and an upper portion of the lower race 8 of the rolling bearing. The circumferential channel 4c comprises a radial return 4d capable of snap-fitting under a shoulder 8f of the lower race 8.

The lips 16a, 16b, 16c and 16d are each in sealed contact, via a flat annular surface, with a radial surface portion. The lips 16a and 16b, radially on either side of the framework, are in sealed contact with the lower face 4a of the upper cover, each on an annular zone of contact axially offset relative to the other. The lip 16d, radially on the outside relative to the framework, is in sealed contact with the upper face 5a of the bearing seat. The lip 16c, radially on the inside relative to the framework, is in sealed contact with an annular contact surface close to a flat ring, situated at the border of a radial surface portion 8a of the lower race 8.

A sealed space 11 is delimited by the lips 16b, 16c, 16d, 16a of the cage, the upper race 7, the lower face 4a of the upper cover, and the lower race 8. This sealed space, as illustrated in FIG. 4, protects the upper race 7 from external attacks, making it possible, as required, to carry out protective surface treatments only on the lower dish-race 8.

Note that, in the embodiments of FIGS. 1 to 4, the surfaces of the races, of the bearing seat or of the cover in contact with the lips are symmetrical of revolution about the axis of the bearing.

The invention is not limited to the embodiments described and may be the subject of many variants. The framework may, for example, be made of low-carbon steel requiring no heat treatment to obtain sufficient hardness, for example a steel of the DC04 type, which, as an indication, contains 0.08% carbon, 0.03% phosphorus, 0.03% sulphur and 0.40% manganese. The sealing lips may therefore be made either by overmoulding a thermoplastic elastomer, or by overmoulding a conventional interlaceable elastomer, such as NBR (AcryloNitrile Butadiene Rubber) or natural rubber. The materials and the geometries of the upper and lower covers may be different from those described. The divided sealing lips may for example be replaced by lips in a single layer but forming a bellows with two folds, one fold of each bellows being in contact with one of the two lower or upper opposing axial surfaces. The geometry of the rolling elements may be other than spherical (rollers, needles, etc.). The rolling elements may be placed on several concentric rolling circumferences, and the framework of the cage may then comprise several concentric rows of housings 12, with a geometry complementing these rolling elements.

The suspension bump stop according to the invention makes it possible to obtain a good seal of the rolling bearing by virtue of the local flexibility of the lip seal, makes it possible to reduce production costs by limiting the number of parts to be assembled thanks to the integration of the seals into the race, and makes it possible to have a sealed contact that is durable over time, the wear of the lips being compensated for by the elastic opening of the “V” of the forked lip. The bearing of the lips on radial surfaces makes it possible to obtain a rolling bearing with a good tolerance to relative misalignment of the two races relative to their common axis.

The intertwining of the materials of the cage and of the race prevents the sealing lip from separating from the cage and remaining, for example, bonded to one of the races. By means of certain configurations of the invention one is able to totally isolate the races from the external surroundings thanks to the seal, which makes it possible to economize on costly surface treatments of the races.

1. An axial thrust bearing system, comprising:
a bearing seat,
an upper cover placed facing the bearing seat, and
a rolling bearing interposed between the upper cover and the bearing seat, and
the rolling bearing comprising:
an upper race secured to the upper cover,
a lower race secured to the bearing seat, and wherein
at least one of the races consisting of a part separate from one of the upper cover and the bearing seat,
rolling elements between the two races, pressing axially on each of the races and travelling on the races, and
a cage for retaining these rolling elements, the cage comprising a framework portion keeping the rolling elements on a rolling circumference, and
at least two circumferential sealing lips made of a more flexible material than the material of the framework,
a first lip, extending substantially radially from an outer periphery of the framework to the outside of the rolling circumference, and
a second lip extending substantially radially from an inner periphery of the framework to the inside of the rolling circumference, characterized in that the first and the second lips are both in sealed contact, on either side of the separate part, with a substantially radial surface portion of one of the upper cover or of the bearing seat.

2. An axial thrust bearing system according to claim 1, wherein at least one of the lips is a double lip in sealed contact with two surfaces axially facing one another.

3. An axial Axial thrust bearing system according to claim 1, in which at least one of the lips is a lip in the form of a bellows with two folds, each fold being in sealed contact with one of the two axial surfaces facing one another.

4. An axial Axial thrust bearing system according to claim 2, wherein the cage further comprises a first double lip in sealed contact with two first surfaces axially facing one another, and a second double lip in sealed contact with two second surfaces axially facing one another, one of the first surfaces and one of the second surfaces being in one and the same plane.

5. An axial Axial thrust bearing system according to claim 2, wherein the cage further comprises a first double lip in sealed contact with two first surfaces axially facing one another, and a second double lip in sealed contact with two second surfaces axially facing one another, the four surfaces being in radial planes of different axial position.

6. An axial Axial thrust bearing system according to claim 1, wherein the framework comprises inserts separating the rolling elements connected by two groups of lateral elements keeping the rolling elements on the rolling circumference, and wherein
the cage comprises at least one lip coupled, by a continuous coupling layer, to one of the groups of lateral elements.

7. An axial thrust bearing system according to claim 6, wherein the coupling layer divides into two lips separated by an axial distance which increases when one moves radially away from the rolling circumference along the lips.

8. An axial Axial thrust bearing system according to claim 1, further comprising at least one lip in sealed contact with the upper race or the upper cover, and comprising at least one lip in sealed contact with one of the lower race and the bearing seat, the surfaces of contact of the lips being normal to the races, and one of the cover and the seat all forming angles of less than 30° relative to the axis of the rolling bearing.

9. An axial Axial thrust bearing system according to claim 1, wherein the lower portion of the upper cover further comprises a circumferential channel capable of covering the upper circumference of the bearing seat, while encompassing the upper race of the rolling bearing and at least a portion of the lower race of the rolling bearing, and at least one lip being in frictional contact with a radial surface portion of the channel, inside the channel.

10. A motor vehicle suspension bump stop, comprising an axial thrust bearing system according to claim 1, wherein the upper cover is secured to the chassis of the vehicle, and the bearing seat rests directly or indirectly on a spring of the vehicle suspension.
